(19) United States
(12) Patent Application Publication
(10) Pub. No.: US 2020/0139169 A1
(43) Pub. Date: May 7, 2020

(54) HVAC FIRE SUPPRESSION SYSTEM

(71) Applicant: Scientific Environmental Design, Inc., High Point, NC (US)

(72) Inventor: Douglas Glass Benefield, Mt. Pleasant, SC (US)

(21) Appl. No.: 16/183,473

(22) Filed: Nov. 7, 2018

(51) Int. Cl. A62C 3/00; A62C 37/36

(52) U.S. Cl. CPC A62C 3/00; A62C 37/04

(57) ABSTRACT

A next generation, integrated HVAC platform incorporating an automated fire sensing, alarm, emergency geo-location/evacuation alert management system, and a clean agent total flooding fire suppression and control system. The fire sensing-alarm and wireless emergency geo-location/evacuation alert management system systems comprise one or more portable self-contained combustion detection-notification and wireless emergency geo-location/evacuation alert appliances deployed at one or more physical locations. The system comprises one or more fire suppressing agent, agent storage container, agent release valve, agent delivery route, and agent dispersion means. The platform incorporates a clean agent total flooding control system comprising an integrated communication means, sensors and wireless devices, to communicate and control one or more HVAC, fire-sensing, fire suppression/protection, and wireless emergency geo-location/evacuation alert management systems, components, or appliances. In the event of a fire, the system enables comprehensive early detection, alarm, alert, and intervention while minimizing potential physical harm to occupants and damage to property.

### FIELD

The present disclosure relates to the field of heating ventilation and air conditioning (HVAC) systems; particularly, a next generation HVAC system incorporating an automated fire sensing, alarm, emergency geo-location/evacuation alert management system, and a clean agent total flooding fire suppression and control system.

### BACKGROUND

Fire, caused by humans or nature, can pose a hazard to people, properties and the environment, potentially resulting in physical injuries, death, and significant economic loss. During 2011-2015, US fire departments responded annually to an estimated average of 358,500 home structure fires. These fires caused an annual average of 2,510 civilian deaths, 12,300 civilian injuries, and $6.7 billion in direct property damage. Cooking equipment was the leading cause of home structure fires and fire injuries and the second leading cause of fire deaths. Smoking materials were the leading cause of home fire deaths. Heating equipment was the second leading cause of home fires and home fire injuries, the third leading cause of home fire deaths, and the leading cause of fire deaths in one- or two-family homes. Almost three of every five (57%) home deaths resulted from fires in homes with no smoke alarms or no working smoke alarms, and only 7% of home fires occurred in properties with fire sprinklers (National Fire Protection Association (NFPA), 2018).

Modern construction materials and manufacturing are becoming more streamlined, efficient, and lightweight. The unintended consequence is that these new fabrication techniques and materials bring new fire safety challenges. In addition, modern furnishings in many households are made with synthetic materials, upholstery stuffed with combustible polyurethane foam, for example, that burn faster than “legacy” furnishings made of leather, wool, and cotton. Industry studies have confirmed that rooms filled with synthetic furniture that are set on fire reach dangerous temperatures more quickly than similar rooms filled with legacy furnishings. In 2013, NFPA reported that fires involving these first-to-ignite synthetic materials accounted for the largest share of fire deaths in reported U.S. home fires. (“What builders need to know about home fire sprinklers,” Supplement to Builder Magazine, December 2014).

The historical standard for fire protection in commercial buildings has been water deployed using sprinklers. Sprinklers are also a proven technology for reducing a fire's impact at home. Home fire sprinklers are now a crucial, life-saving technology, since sprinklers can reduce the risk of dying from home fires by 80 percent and can reduce the risk of property loss by 70 percent. Statistics show, however, that a very small percentage (7%) of reported home fires occurred with sprinklers present (NFPA, 2018). The possible impediments for deploying sprinklers in the home include installation costs, potential water damage to property, and home structure (e.g., ceiling) aesthetics.

An alternative to sprinkler fire protection methods is gaseous fire suppression, also known as Clean Agent Fire Suppression, which is the use of inert gases and chemical agents to extinguish a fire. Clean agent fire extinguishing systems utilize clean agent gaseous chemicals to combat fires caused by certain fire hazards. Clean agents include both halocarbon and inert gaseous agents. Inert gases are widely used in the fire industry as extinguishing agents for total flooding fire suppression systems within normally occupied areas. These gases are very effective and suppress fires by oxygen depletion, creating a surrounding atmosphere where combustion processes are unsustainable, resulting in rapid fire extinguishment. Gaseous fire suppression systems typically consist of a(n) agent, agent storage containers, agent release valves, fire detectors, agent delivery piping, and agent dispersion nozzles installed on ceilings. Fire-suppressive gases of varying compositions are supplied by a variety of manufacturers. The physically inert gases are electrically non-conductive, non-toxic and environmentally friendly, making them a perfect choice for the fire protection of normally occupied areas and valuable equipment. Clean agents are generally deployed in commercial facilities to protect occupants, building aesthetics and structure, computer and network hardware, irreplaceable data, artifacts, financial records, and historical documents.

In general, a fire alarm system based on early detection, employed in combination with procedures or instructions, reduces the risk of fire and potential harm to the commercial or home occupants. The “early detection” principle is to provide the earliest possible notification of the outbreak of a fire so that occupants are given enough time to intervene or evacuate before the outbreak develops into a major fire resulting in property damage or physical harm. Ideally, all rooms are equipped with smoke detectors connected to an automatically addressable fire alarm system to enable the detection of smoke generation/fire and alarm activation. Currently, fire alarm activation is limited to the activation of a local audible alarm leading to the implementation of measures described in local fire protection regulations (e.g., notification of fire contingency procedures, evacuation, damage control, etc.) and emergency notification to external fire-fighting services or first responders.

Therefore, the need exists for a next generation HVAC system incorporating an automated fire sensing-alarm, fire suppression/protection, occupant geo-location, and emergency evacuation alert management system. The fire detection, alert, and non-destructive suppression system should incorporate wireless sensors and communication technology for early detection, alarm activation, and emergency evacuation alert management.

Through applied effort, ingenuity, and innovation, Applicant has identified deficiencies and problems with existing fire detection and suppression systems. Applicant has developed a solution that is embodied by the present invention, which is described in detail below.

### SUMMARY

The following presents a simplified summary of some embodiments of the invention to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

An object of the present disclosure is an integrated HVAC and fire suppression platform incorporating an automated fire sensing-alarm system, a fire suppression/protection system, a wireless emergency geo-location/evacuation alert management system, and a clean agent total flooding control system. In the event of a fire, the integrated platform enables comprehensive early detection, alarm, alert, and intervention while minimizing potential physical harm to occupants and damage to property.

An object of the present disclosure is a fire sensing-alarm system comprising one or more portable self-contained combustion detection-notification appliance deployable at one or more physical locations within said platform, building, structure, house, or the like. The combustion detection-notification appliance contains at least one optical (e.g., photodiode, IR, etc.), gas (e.g., O2, CO, CO2, methane, etc.), electro-chemical, ionization, temperature, particle, CCD sensor (e.g., camera), sensor array, or sensor suite for sensing the presence of combustion, fire, or the like. The combustion detection-notification appliance contains at least one alarm indication means, including but not limited to light, sound, audible alarm, or vibrating means, to alert occupants or emergency responders to the initiation or emergence of a fire or the like, through audible or visual means. In various embodiments, the combustion detection-appliance incorporates wireless communication means to enable the remote identification or location of smoke or fire combustion. In various embodiments, the combustion detection-appliance incorporates wireless communication means to enable wireless mobile notification of the initiation or emergence of smoke, combustion, fire, or the like, to one or more occupant or fire department or first responder. The wireless notification means includes, but is not limited to, text message, IP address, SMS text, audible alarm, voice, image, video, or the like. The fire-sensing alarm system operates in conjunction with one or more said HVAC system, fire suppression/protection, wireless emergency geo-location/evacuation alert management system, and clean agent total flooding control system to enable early fire detection, alarm, alert, and intervention while minimizing potential physical harm to occupants and damage to property.

An object of the present disclosure is a fire suppression/protection system comprising one or more fire suppressing agent, agent storage container (e.g., canister, tank, etc.), agent release valve, agent delivery route, and agent dispersion means. In various embodiments, the fire suppressing agent comprises one or more chemical agent, gaseous agent, or clean agent. In various embodiments, the clean agent is a halocarbon, halogenated, or inert gaseous agent. In various embodiments, the agent storage container, release valve, delivery route, and dispersion means incorporate one or more sensors to enable automatic remote actuation, feedback, monitoring, fault detection, or maintenance. In various embodiments, the agent delivery route includes but is not limited to one or more HVAC ductwork or ventilation route. In various embodiments, the dispersion means include but are not limited to at least one nozzle. In various embodiments, the nozzles are placed within one or more HVAC duct or vent. In various embodiments, the nozzles are placed to dispense the clean agent within the direct airflow of said HVAC duct, or vent. In various embodiments, the nozzles are placed to dispense the clean agent into one or more enclosed space (e.g., room, office, hallway, closet, kitchen, etc.) of a building or home. The fire suppression/protection system operates in conjunction with one or more said HVAC, wireless emergency geo-location/evacuation alert management system, and clean agent total flooding control system to enable early detection, alarm, alert, and intervention while minimizing potential physical harm to occupants and damage to property.

An object of the present disclosure is a wireless emergency geo-location/evacuation alert management system comprising one or more portable appliances for placement in one or more locations of a building or home structure. The locations include but are not limited to a floor, door, window, ceiling, room, hallway, kitchen, furniture, counter, closet, cabinet, basement, attic, HVAC ductwork, vent, garage, ceiling, front/back door, deck, porch, or the like. The appliance incorporates one or more remote sensors and wireless communication means to enable detection of the presence of an occupant in the vicinity. In various embodiments, the wireless communication means enables the detection of the presence of one or more mobile communication devices of one or more occupants. In various embodiments, the wireless communication means enables the transmission of one or more text message, SMS text, audible alarm, voice, image, video, or the like to one or more mobile communication devices of one or more occupants. The said transmission includes but is not limited to audible or visible building status, alerts, instructions, or directions for evacuation. In various embodiments, the appliance incorporates at least one speaker for broadcasting at least one audible status, alarm, alert, or instructions for evacuation. In various embodiments, one or more appliance operates in conjunction to determine the presence or location of one or more occupants within the building or home structure. The wireless emergency geo-location/evacuation alert management system operates in conjunction with one or more said HVAC, fire suppression/protection, and clean agent total flooding control system to enable early detection, alarm, alert, and intervention while minimizing potential physical harm to occupants and damage to property.

An object of the present disclosure is a clean agent total flooding control system (“control system”) comprising integrated communication means, said sensors and wireless devices, to communicate and control one or more said HVAC, fire-sensing, fire suppression/protection, and wireless emergency geo-location/evacuation alert management systems, components, or appliances. In various embodiments, the control system detects the emergence and location of a combustion or fire via said appliances and automatically actuates one or more blowers, inverters, dampers, air bypass, or vents of said HVAC system. In various embodiments, the control system automatically and rapidly delivers one or more clean agents through at least one duct, ductwork, or vent of said HVAC system for fire suppression at specifically said determined location. In various embodiments, the control system determines the emergence and location of a combustion or fire and automatically interrogates data from one or more said appliances to determine the presence, movement, location, or number of occupants of a building or home. Upon determination, the control system communicates or controls one or more said appliances to deliver, sequentially or simultaneously, one or more text message, SMS text, audible alarm, voice, image, video, or the like, including instructions or directions for immediate evacuation from a specific location, room, premise, structure, building, or home to one or more mobile communication devices of one or more occupants. In various embodiments, the control system communicates or controls one or more said appliances to deliver an audible status, alarm, alert, instructions, or directions for immediate evacuation from a specific location, room, premise, structure, building, or home. In the event of a fire, the said clean agent total flooding control system enables early fire detection, alarm, alert, and intervention while minimizing potential physical harm to occupants and damage to property.

An object of the present disclosure is a clean agent total flooding control system accessible and configurable from an external, remote, or wireless mobile controller. The said controller may include but is not limited to a thermostat, smart thermostat, smart environment controller, wall-mounted control unit, hand-held controller, computing device, computer, laptop, computing mobile device, mobile phone, smart mobile phone, cloud server, or the like. In various embodiments, the controller provides computing memory storable options for configuring the platform with the non-limiting following parameters: type of sensors, HVAC system and components operation, alarm, alert, text message, SMS text, audible alarm, voice, image, video, or the like, including instructions or directions for immediate evacuation from a specific location, room, premise, structure, building, or home. In various embodiments, the inputs for the platform settings may be sent to a HVAC control system using a computing application software. In various embodiments, the application software may execute its instructions on a computing system, a computing device, computer, laptop, computing mobile device, automobile computing multimedia system, mobile phone, smart mobile phone, mobile app, cloud server, or the like. In various embodiments, the said control system may communicate and operate in coordination with one or more external fire department or emergency management system. The application software may include a graphical user interface enabling the user of the application to view related information including the current state of the said integrated HVAC and fire suppression system.

Specific embodiments of the present disclosure provide for an interior fire suppression system comprising an air handler, the air handler comprising a housing, a blower, and a return air plenum; at least one fire suppression agent container coupled to an interior portion of the air handler, the at least one fire suppression agent container containing a pressurized fire suppression agent, the at least one fire suppression agent container being positioned downstream of an air flow path of the blower; and, a release valve operably engaged with the at least one fire suppression agent container to selectively release the pressurized fire suppression agent from the at least one fire suppression agent container, the release valve having an electronic actuator, the electronic actuator being configured to selectively open and close the release valve.

Further specific embodiments of the present disclosure provide for an interior fire suppression system comprising an air handler, the air handler comprising a housing, a blower, and a return air plenum; at least one fire suppression agent container coupled to an interior portion of the air handler, the at least one fire suppression agent container containing a pressurized fire suppression agent, the at least one fire suppression agent container being positioned downstream of an air flow path of the blower; a release valve operably engaged with the at least one fire suppression agent container to selectively release the pressurized fire suppression agent from the at least one fire suppression agent container, the release valve having an electronic actuator, the electronic actuator being configured to selectively open and close the release valve; one or more motorized dampers configured to be installed in one or more ducts of an interior ventilation system, the one or more motorized dampers being configured to selectively open and close an airflow path; one or more fire detection sensors configured to be installed in one or more interior rooms of a dwelling; and, a controller operably engaged with the blower, the electronic actuator of the release valve, the one or more motorized dampers, and the one or more fire detection sensors, the controller being configured to execute a plurality of fire suppression commands in response to a fire detection input from the one or more fire detection sensors.

Still further specific embodiments of the present disclosure provide for an interior fire suppression system comprising an air handler, the air handler comprising a housing, a blower, and a return air plenum; at least one fire suppression agent container coupled to an interior portion of the air handler, the at least one fire suppression agent container containing a pressurized fire suppression agent, the at least one fire suppression agent container being positioned downstream of an air flow path of the blower; a release valve operably engaged with the at least one fire suppression agent container to selectively release the pressurized fire suppression agent from the at least one fire suppression agent container, the release valve having an electronic actuator, the electronic actuator being configured to selectively open and close the release valve; one or more motorized dampers configured to be installed in one or more ducts of an interior ventilation system, the one or more motorized dampers being configured to selectively open and close an airflow path; one or more fire detection sensors configured to be installed in one or more interior rooms of a dwelling; a controller operably engaged with the blower, the electronic actuator of the release valve, the one or more motorized dampers, and the one or more fire detection sensors, the controller being configured to execute a plurality of fire suppression commands in response to a fire detection input from the one or more fire detection sensors; and, an application server operably engaged with the controller over a wireless communications network, the application server being operable communicate a fire detection event to one or more third-party systems.

The foregoing has outlined rather broadly the more pertinent and important features of the present invention so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF DRAWINGS

The above and other objects, features and advantages of the present disclosure will be more apparent from the following detailed description taken in conjunction with the accompanying drawings, in which:

FIG. 1 is an illustration of a portable self-contained combustion detection-notification appliance, according to an embodiment;

FIG. 2 is a system diagram highlighting the components of an integrated HVAC platform incorporating a fire suppression/protection system, according to an embodiment;

FIG. 3 is a system diagram of a wireless emergency geo-location/evacuation alert management system, according to an embodiment; and,

FIG. 4 is a functional block diagram illustrating the process flow of the integrated HVAC fire detection, suppression, and alert system, according to an embodiment.

### DETAILED DESCRIPTION

Exemplary embodiments are described herein to provide a detailed description of the present disclosure. Variations of these embodiments will be apparent to those of skill in the art. Moreover, certain terminology is used in the following description for convenience only and is not limiting. For example, the words “right,” “left,” “top,” “bottom,” “upper,” “lower,” “inner” and “outer” designate directions in the drawings to which reference is made. The word “a” is defined to mean “at least one.” The terminology includes the words above specifically mentioned, derivatives thereof, and words of similar import.

According to various embodiments of the present disclosure, the factors and limitations of prior art fire detection, alert, and fire suppression systems are solved with a next generation, integrated HVAC platform incorporating an automated fire sensing, alarm, emergency geo-location/evacuation alert management system, and a clean agent total flooding fire suppression and control system. In the event of a fire, the integrated platform enables comprehensive early detection, alarm, alert, and intervention while minimizing potential physical harm to occupants and damage to property.

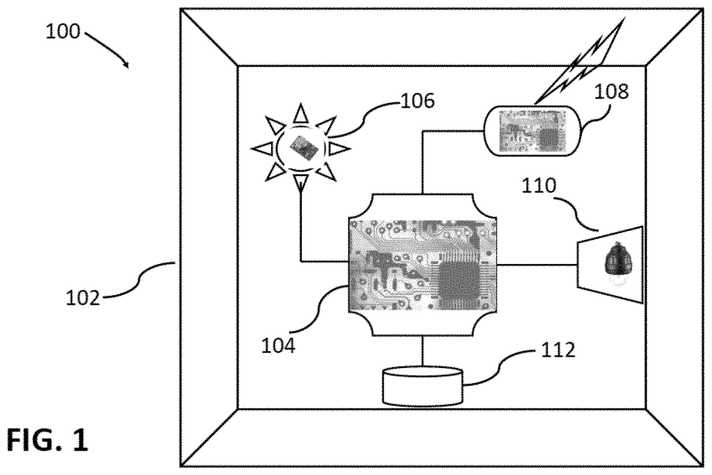

FIG. 1 is an illustration 100 of a portable self-contained combustion detection-notification appliance 102 deployable at one or more physical locations within said platform, building, structure, house, or the like. The combustion detection-notification appliance 102 comprises a central controller motherboard 104 operating to send or receive electrical signals from one or more sensor(s) 106, a wireless transceiver module 108, and a broadcast alarm module 110. The appliance and its electronics components are energized by power source 112, including but not limited to a battery, an AC, DC, photovoltaic, or the like. In various embodiments, motherboard 104 contains special-purpose hardware (e.g., FPGA, ASIC, PLD, etc.), programmable circuitry, or combinations thereof, incorporating one or more microcontroller, CPU, voltage input, analog-digital I/O, analog-digital converter, modulation I/O, memory device (e.g., flash memory, PROM, RAM, SRAM, etc.), UART, SDA & SCL pins, and crystal oscillator. Motherboard 104 is electronically configured or programmed with firmware and/or software to send or receive data to communicate or control the operation of one or more sensors 106, which include at least one of optical, gas, temperature, electro-chemical, ionization, particle, piezoelectric, ultrasonic, RF, CCD sensor, CCD array, sensor array, or sensor(s) suite for sensing the presence of combustion, flame, fire, or the like.

In various embodiments, sensor(s) 106 may include a motion sensor for detecting the movement or presence of an occupant. Depending on the type of sensors (e.g., 02, CO & CO₂ gas sensors, methane, butane, etc.) employed, motherboard 104 is configured to convert analog sensor signals to digital for further processing and operation. One or more microcontroller or CPU may be programmed to determine one or more parameters (e.g., signal threshold, motion, etc.) from data generated by a sensor. In a similar manner, motherboard 104 is configured to send or receive data to communicate or control the operation of transceiver module 108. In various embodiments, transceiver module 108 comprises at least one wireless communication transmitter-receiver device capable of executing one or more network communication protocol or standard, including but not limited to 802.11n wireless LAN, Bluetooth™, BLE wireless fidelity (WIFI), Bluetooth low energy (BLE), ZigBee™, near field communication (NFC), magnetic secure transmission, radio frequency (RF), RFID, or body area network (BAN). In various embodiments, motherboard 104 is configured to enable the remote identification or location of smoke, flame, combustion, or fire via transceiver module 108 and one or more wireless network routers (e.g., WiFi Router). The location of appliance 102 may be determined through the assignment of an IP or MAC address for transceiver module 108 and determining a physical location assigned to the module corresponding with its IP or MAC address, such information retrieved from a database. In various embodiments, motherboard 104 is configured to enable the remote identification or location of smoke, flame, combustion, or fire via transceiver module 108 incorporating cellular communication hardware, middle, firmware, software, or combinations thereof, to enable triangulation and or GPS geo-location/fencing. In various embodiments, the combustion detection-appliance 102 incorporates wireless communication means of transceiver module 108 to enable wireless mobile notification of the initiation or emergence of smoke, flame, combustion, fire, or the like, to one or more occupants of a building or home or externally to a fire department or first responder. The wireless notification includes but is not limited to text message, SMS text, audible alarm, voice, image, video, or the like. In another similar manner, motherboard 104 is configured to send or receive data to communicate or control the operation of broadcast alarm module 110 which may include at least one non-limiting alarm indication means such as light, sound, bullhorn, audible alarm, or vibrating means, to alert, audibly or visually, occupants or emergency responders to the initiation, emergence, or presence of a fire or the like.

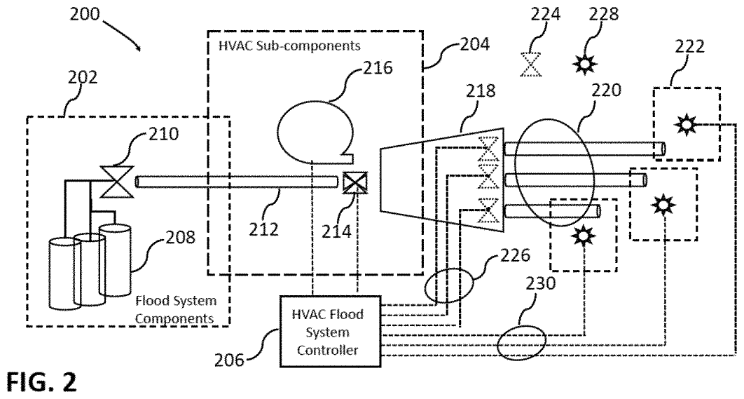

Now referring to FIG. 2, a system diagram 200 highlighting the components of an integrated HVAC platform incorporating a fire suppression/protection system is shown. The integrated platform comprises flood system 202 of a clean agent total flooding system and sub-components 204 of an HVAC system whereby all components are electronically, operably connected, enabling electronic control by a system controller 206. Those skilled in the art will appreciate that various other components (not shown) may be included in the said HVAC platform. Flood system 202 comprises one or more agent storage containers (e.g., canister, tank, etc.) 208, containing one or more fire suppressing agent, operably connected to one or more agent release valve 210, agent delivery route 212, and agent dispersion means 214. In various embodiments, the fire suppressing agent comprises one or more chemical agent, gaseous agent, or clean agent. In various embodiments, the clean agent is a halocarbon, halogenated, pressurized gas (e.g., CO2, Nitrogen, etc.) or inert gaseous agents. In various embodiments, the agent storage container 208, release valve 210, delivery route 212, and dispersion means 214 incorporate one or more sensors, micro switches, or combinations thereof, to enable automatic remote actuation, feedback, status or function monitoring, fault detection, or maintenance. In some embodiments, the fire suppression system can monitor and report the status of agent storage container 208 using either existing micro switches or the physical position of agent storage container 208. HVAC system 204 comprises primary operably connected sub-components blower 216, air flow distributor 218, and one or more ductwork 220, supplying air to one or more location 222 within a building or residential structure. Air flow distributor 218 incorporates the use of one or more air flow damper actuators 224 enabling direct, selective, or total control of airflow into individual duct work 220, subsequently into for example a room, under the command of controller 206 via one or more communication route 226. Exemplary communication route 226 may include non-limiting direct electrical connection (shown as dotted lines), wireless transmission, or combinations thereof. In various embodiments, controller 206 enables the direct, selective or total control of airflow in conjunction with one or more sensing units 228 via one or more communication route 230. In a preferred embodiment, sensing units 228 comprise one or more said combustion detection-notification appliance 102, of FIG. 1. Exemplary communication route 230 may include non-limiting direct electrical connection (shown as dotted lines), wireless transmission enabled by detection-notification appliance 102, or combinations thereof. In various embodiments, the agent delivery route 212 includes but is not limited to one or more HVAC plenum, ductwork or ventilation route. In various embodiments, the dispersion means 214 includes but is not limited to at least one nozzle. In various alternative embodiments, the nozzles are placed within one or more HVAC ductwork 220. In various alternative embodiments, the nozzles are placed to dispense the clean agent within the direct airflow of said HVAC, plenum, duct, vent, or combinations thereof. In various embodiments, the nozzles are placed to dispense the clean agent into one or more enclosed space 222 (e.g., room, office, hallway, closet, kitchen, etc.) of a building or residential structure. The total flood system 202 operates in conjunction with one or more said HVAC sub-components 204, wireless emergency geo-location/evacuation alert management system, and clean agent total flooding control system to enable early detection, alarm, alert, and intervention while minimizing potential physical harm to occupants and damage to property. According to one or more embodiments of the present disclosure, system 200 may be comprised of two or more assemblies of flood system 202. The two or more assemblies of flood system 202 may be housed in or directly connected to the one or more HVAC ductwork 220. The two or more assemblies of flood system 202 may be operably engaged with HVAC flood system controller 206 to disperse the fire suppressing agent contained in one or more agent storage container 208 into one or more of the desired HVAC ductwork 220. This embodiment may be utilized in larger structures where a single, centralized embodiment of flood system 202 may be insufficient to adequately suppress an interior fire based on the volume of the subject space.

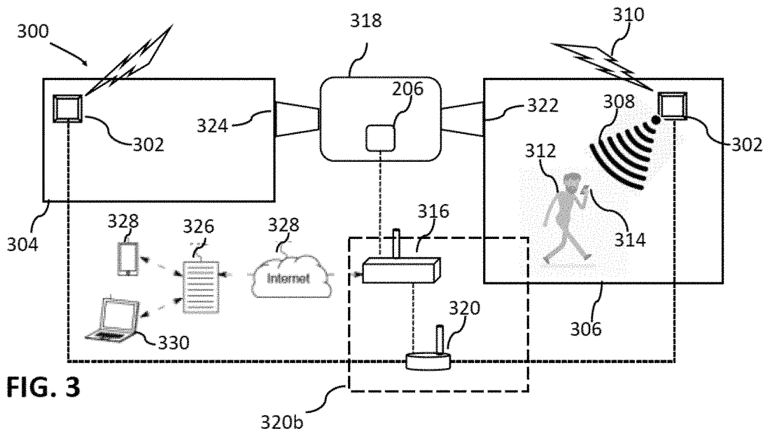

Now referring to FIG. 3, a system diagram 300 of a wireless emergency geo-location/evacuation alert management system is shown. The alert management system comprises one or more portable appliances 302, corresponding to detection-notification appliance 102, of FIG. 1, for placement in one or more locations within a room 304, 306 of a building or home structure. The location includes but is not limited to a floor, door, window, ceiling, room, hallway, kitchen, furniture, counter, closet, cabinet, basement, attic, HVAC ductwork, vent, garage, ceiling, front/back door, deck, porch, or the like. The appliance 302 incorporates one or more remote sensors 308 and wireless communication means 310 to enable detection of the presence of an occupant 312 in the vicinity. In various alternative embodiments, the communication routes may include non-limiting direct electrical connection (shown as dotted lines), wireless transmission enabled by detection-notification appliance 302, or combinations thereof. In various embodiments, the wireless communication means 310 enables the detection of the presence of one or more mobile communication devices 314 in possession or vicinity of one or more occupants. In various embodiments, the wireless communication means enables the transmission-reception of one or more text message, SMS text, audible alarm, voice, image, video, or the like to one or more mobile communication devices of one or more occupants. The transmission includes, but is not limited to, audible or visible building status, alerts, instructions, or directions for evacuation. In various embodiments, the detection-notification appliance 302 incorporates at least one speaker for broadcasting at least one audible status, alarm, alert, or instructions for evacuation. In various embodiments, one or more appliance 302 operates in conjunction to determine the presence or location of one or more occupants within the building or home structure. The wireless emergency geo-location/evacuation alert management system also comprises a controller unit 316 configured to operably control an integrated HVAC and fire suppression system 318 via HVAC flood system controller 206 illustrated in FIG. 2. Controller unit 316 may comprise a central controller motherboard electronically configured with hardware-software and programmed with firmware and or software to send or receive data to communicate or operate controller 206 and for wireless communication to/from a wireless router 320, or combinations thereof. Wireless router 320 is preferably placed at a location 320b near one or more detection-notification appliance 302 within a building or residential structure. The motherboard contains special-purpose hardware (e.g., FPGA, ASIC, PLD, etc.), programmable circuitry, or combinations thereof, incorporating one or more microcontroller, CPU, voltage input, analog-digital I/O, analog-digital converter, modulation I/O, RF circuit, RF transceiver, SIM module, GPS transceiver, memory device (e.g., flash memory, PROM, RAM, SRAM, etc.), UART, SDA & SCL pins, and crystal oscillator. In various embodiments, one or more portable appliance 302 routinely and systematically sends data from sensors, IP or MAC address, functional, operational information, or combinations thereof to router 320.

In various embodiments, controller 316 under logic queries router 320 for information and subsequently controls the airflow into a room 304, 306 under the operation of HVAC and fire suppression system 318 through airflow conduit 322 or 324 depending on the initiation or presence of smoke, combustion or fire, as well as the presence of occupant 312. In various alternative embodiments, controller 316 and wireless router 320 can be combined into one unit. In another alternative embodiment, HVAC and fire suppression system 318 may incorporate one or more controller 206, controller 316, and router 320 into a single unit. Controller unit 316 is also configured to operably connect to a cloud server 326 via Internet 328. Cloud server 326 is made accessible to one or more wireless mobile device 328 or a client computing device 330. Cloud server 326 comprises a database and software application, including an automated administration system (“Admin”), for user access to the alert management system 300. In various embodiments, controller unit 316 accepts one or more input from an external, remote, or wireless controller, thermostat, smart thermostat, smart mobile device (e.g., phone) 328, computing device 330, cloud server 326, or the like. In various embodiments controller unit 316 sends and receives data relating to the HVAC and fire alarm and suppression system settings using said hardware and software data communication means via local area network (LAN), local wireless, wide-area wireless, cellular, intranet, Internet, or the like. In various embodiments, the inputs for the system settings may be sent to the HVAC controller 206 using a computing application software stored in, for example, a remote control, computing device, smart mobile device, smart thermostat, or cloud server. In various embodiments, the application software may execute its instructions on a computing system, a computing device (e.g., device 330), computing mobile device, mobile phone, smart mobile phone (e.g., device 328), mobile app, cloud server (e.g., device 326), or the like. In various embodiments, the controller unit 316 may communicate and function with an external fire or emergency management control system, via for example, the Internet, intranet, short wireless, wireless, a LAN, a WAN, wireless cellular network, or the like.

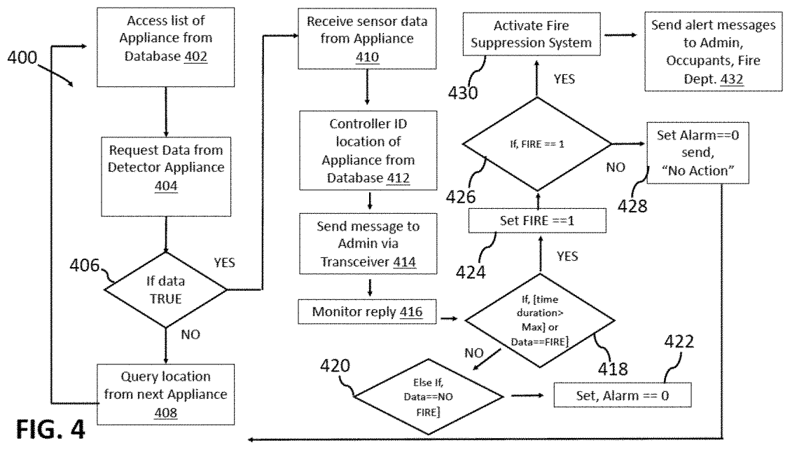

Referring now to FIG. 4, a functional block diagram illustrating the process flow of the integrated HVAC fire detection, suppression, and alert system is shown. At initial step 402, controller unit 316 accesses a list/inventory of Appliance 102 from a database located on cloud server 326. At a second step 404, controller unit 316 requests data from a specific appliance using said inventory. A decision is made at step 406, whereby controller unit 316 requests data to identify said specific Appliance 102 and If “NO” then controller unit 316 proceeds to step 408, querying another location from a next Appliance 102. If appliance data is “YES” at step 406 then controller unit 316 proceeds to request to receive sensor data from the appliance at step 410. Controller unit 316 then identifies at step 412 the specific appliance's location using information located within database. Controller unit 316 can then send a message to the automated Admin system to inform device status at step 414.

Controller unit 316 monitors at step 416 any reply from Admin. Another decision is made at step 418 whereby controller unit 316 determines the presence or absence of a combustion, smoke, flame, fire or combinations thereof using sensor data from an appliance. If data is equal to “NO” then the controller proceeds to step 420 where Admin is informed “NO FIRE” and subsequently sets the status of Alarm equal to zero with step 422. A decision of “YES” at step 418 advances the system to a status of “FIRE” being positive (e.g. equal to binary 1) at 424 triggering another decision step 426 in which case a “NO” decision leads to a setting of an alarm status to Null (e.g., equal to binary 0) at 428. A decision of “YES” would activate the said fire suppression system of FIG. 2 at step 430 and subsequently step 432, the activation of said wireless emergency geo-location/evacuation alert management system of FIG. 3.

The present disclosure includes that contained in the appended claims as well as that of the foregoing description. Although this invention has been described in its exemplary forms with a certain degree of particularity, it is understood that the present disclosure of has been made only by way of example and numerous changes in the details of construction and combination and arrangement of parts may be employed without departing from the spirit and scope of the invention. The terms and expressions which have been employed in the foregoing description are used therein as terms of description and not of limitation, and there is no intention in the use of such terms and expressions to exclude equivalents of the features shown and described or portions thereof, it being recognized that the scope of the invention is defined and limited only by the claims which follow.

What is claimed is:

1. An interior fire suppression system comprising:
an air handler, the air handler comprising a housing, a blower, and a return air plenum;
at least one fire suppression agent container coupled to an interior portion of the air handler, the at least one fire suppression agent container containing a pressurized fire suppression agent, the at least one fire suppression agent container being positioned downstream of an air flow path of the blower; and,
a release valve operably engaged with the at least one fire suppression agent container to selectively release the pressurized fire suppression agent from the at least one fire suppression agent container, the release valve having an electronic actuator, the electronic actuator being configured to selectively open and close the release valve.

2. The interior fire suppression system of claim 1 further comprising a controller operably engaged with the air handler and the electronic actuator.

3. The interior fire suppression system of claim 2 further comprising at least one fire detection sensor operably engaged with the controller.

4. The interior fire suppression system of claim 3 wherein the controller is configured to control a fan speed of the blower in response to sensor data from the at least one fire detection sensor.

5. The interior fire suppression system of claim 3 wherein the controller is configured to engage the electronic actuator in response to sensor data from the at least one fire detection sensor.

6. The interior fire suppression system of claim 1 further comprising a dispersion nozzle operably engaged with the at least one fire suppression agent container.

7. An interior fire suppression system comprising:
an air handler, the air handler comprising a housing, a blower, and a return air plenum;
at least one fire suppression agent container coupled to an interior portion of the air handler, the at least one fire suppression agent container containing a pressurized fire suppression agent, the at least one fire suppression agent container being positioned downstream of an air flow path of the blower;
a release valve operably engaged with the at least one fire suppression agent container to selectively release the pressurized fire suppression agent from the at least one fire suppression agent container, the release valve having an electronic actuator, the electronic actuator being configured to selectively open and close the release valve;
one or more motorized dampers configured to be installed in one or more ducts of an interior ventilation system, the one or more motorized dampers being configured to selectively open and close an airflow path;
one or more fire detection sensors configured to be installed in one or more interior rooms of a dwelling; and,
a controller operably engaged with the blower, the electronic actuator of the release valve, the one or more motorized dampers, and the one or more fire detection sensors, the controller being configured to execute a plurality of fire suppression commands in response to a fire detection input from the one or more fire detection sensors.

8. The interior fire suppression system of claim 7 wherein the plurality of fire suppression commands comprise configuring a fan speed of the blower.

9. The interior fire suppression system of claim 7 wherein the plurality of fire suppression commands comprise engaging the electronic actuator to open the release valve.

10. The interior fire suppression system of claim 7 wherein the plurality of fire suppression commands comprise configuring at least one motorized damper of the one or more motorized dampers to a closed position.

11. The interior fire suppression system of claim 7 wherein the plurality of fire suppression commands comprise configuring at least one motorized damper of the one or more motorized dampers to an open position.

12. An interior fire suppression system comprising:
an air handler, the air handler comprising a housing, a blower, and a return air plenum;
at least one fire suppression agent container coupled to an interior portion of the air handler, the at least one fire suppression agent container containing a pressurized fire suppression agent, the at least one fire suppression agent container being positioned downstream of an air flow path of the blower;
a release valve operably engaged with the at least one fire suppression agent container to selectively release the pressurized fire suppression agent from the at least one fire suppression agent container, the release valve having an electronic actuator, the electronic actuator being configured to selectively open and close the release valve;
one or more motorized dampers configured to be installed in one or more ducts of an interior ventilation system, the one or more motorized dampers being configured to selectively open and close an airflow path;
one or more fire detection sensors configured to be installed in one or more interior rooms of a dwelling;
a controller operably engaged with the blower, the electronic actuator of the release valve, the one or more motorized dampers, and the one or more fire detection sensors, the controller being configured to execute a plurality of fire suppression commands in response to a fire detection input from the one or more fire detection sensors; and,
an application server operably engaged with the controller over a wireless communications network, the application server being operable to communicate a fire detection event to one or more third-party systems.

13. The interior fire suppression system of claim 12 further comprising a smart device operably engaged with the application server over the wireless communications network, the smart device being configured to configure one or more system settings of the controller.

14. The interior fire suppression system of claim 12 wherein the plurality of fire suppression commands comprise configuring a fan speed of the blower.

15. The interior fire suppression system of claim 12 wherein the plurality of fire suppression commands comprise engaging the electronic actuator to open the release valve.

16. The interior fire suppression system of claim 12 wherein the plurality of fire suppression commands comprise configuring at least one motorized damper of the one or more motorized dampers to a closed position.

17. The interior fire suppression system of claim 12 wherein the plurality of fire suppression commands comprise configuring at least one motorized damper of the one or more motorized dampers to an open position.

18. The interior fire suppression system of claim 12 further comprising one or more occupant detection sensors configured to be installed in the one or more interior rooms of the dwelling.

19. The interior fire suppression system of claim 12 wherein the one or more third-party systems comprise an external fire management system or emergency management control system.

20. The interior fire suppression system of claim 18 wherein the controller is configured to communicate sensor data from the one or more occupant detection sensors and the one or more fire detection sensors to the application server over the wireless communications network.
